(19) United States
(12) Patent Application Publication
(10) Pub. No.: US 2003/0009688 A1
(43) Pub. Date: Jan. 9, 2003

(54) Method for communicating data relating to intellectual property applications between a user and a receiver

(76) Inventors: Christian Schmidt, Munchen (DE); Dieter Pellkofer, Eichenau (DE)

Correspondence Address: Gifford, Krass, Groh, Sprinkle,, Anderson & Citkowski, P.C., Suite 400, 280 N. Old Woodward Ave., Birmingham, MI, 48009, US

(21) Appl. No.: 09/900,991

(22) Filed: Jul. 9, 2001

(51) Int. Cl. G06F 11/30

(52) U.S. Cl. 713/200

(57) ABSTRACT

A system and method for communicating data between a user and a receiver over a telecommunications network is disclosed in which the data relates to filing information for applications relating to the protection of intellectual property. The method includes the step of the receiver initially registering the user to communicate the application data over the network to the receiver. Thereafter, the user transmits data to the receiver relating to the intellectual property application via the network. The receiver verifies the completeness of the transmitted data from the user and, thereafter, confirms receipt of the verified data over the network to the user.

### BACKGROUND OF THE INVENTION

I. Field of the Invention

The present invention relates generally to communications and, more particularly, to a system and method for communicating data over a telecommunication network in which the data relates to applications relating to the protection of intellectual property.

II. Description of the Prior Art

In order to acquire legal protection for different types of intellectual property, such as patents and trademarks, it is necessary to file formal application papers in the country or countries for which protection of the intellectual property is desired. Furthermore, unless the formal application papers are filed with the appropriate government agency, protection of the intellectual property in any given particular country will typically not be effective.

Many foreign countries, furthermore, will only accept applications to protect intellectual property if the application is filed by a professional licensed by that agency. In many cases, the licensed individual must also be a national or reside within the country.

Consequently, in order to obtain intellectual property protection in foreign countries, it has been the previously known practice to forward the formal application papers by mail or courier to licensed professionals who reside in foreign countries. Those licensed professionals then file the application papers in the appropriate agency in an effort to perfect and protect the intellectual property.

There are, however, disadvantages to this previously known method for obtaining protection of intellectual property in foreign countries. A primary disadvantage is that the actual forwarding of the application papers from one country and to a foreign country by mail or courier is time consuming and relatively expensive. While the use of facsimile transmission reduces both the cost and time to forward the application papers from one country and to a foreign country, the actual quality of the facsimile transmission is oftentimes inadequate to effect the filing at the appropriate government agency. Additionally, in some countries, the use of facsimile transmissions rather than original documents, at least for some documents, is unacceptable so that the documents must be retyped at the receiving end. This, of course, disadvantageously introduces errors or at least the possibility of errors in the application papers.

A still further disadvantage of transmitting the application papers by facsimile from one country and to a foreign country is that the transmitter of the application data is unable to confirm with certainty that the facsimile copy was actually received by the receiver in the foreign country. While many facsimile machines do provide a return receipt indicative that the facsimile transmission was actually received by the facsimile machine at the receiver in the foreign country, such a receipt does not guarantee that the facsimile transmission was actually successfully printed in hard copy form in the place receiving the facsimile transmission.

### SUMMARY OF THE PRESENT INVENTION

The present invention provides a system and method for transmitting application data relating to applications for the protection of intellectual property which overcomes all of the above-mentioned disadvantages of the previously known methods. Furthermore, as used in this application, the term “application” for the protection of intellectual property includes not only patent and trademark applications, but also other documents, such as annuity reminders, renewals, and the like relating to issued patents as well as issued trademark registrations and/or certificates.

In brief, in the method of the present invention, the receiver, i.e. the foreign professional receiving the facsimile from the home country, initially registers each user. The receiver typically utilizes various criteria, such as financial standing and credit worthiness, in order to enable registration of any particular user to use the system. However, upon registration, the user selects not only a user identification (user ID) but also a user password to ensure use of the system only by authorized users. Both the user ID as well as the user password are stored at the receiver and preferably the receiver retransmits both the password and the user ID to the user over the telecommunication network for confirmation purposes.

After registration by the user, the user is authorized to transmit data to the receiver relating to intellectual property applications. Such data would typically include the applicant's name, applicant's address, filing serial numbers as well as data relating to the intellectual property itself. Since this data is communicated over the telecommunication network, the transmission of the data is virtually instantaneous.

Each application for the protection of intellectual property must contain at least some minimal information, such as the owner's name, serial numbers, etc. in order to comprise a complete application for the protection of that particular intellectual property. Therefore, the receiver verifies the completeness of the transmitted data from the user and, after such verification, confirms receipt of the verified data over the telecommunication network to the user.

### BRIEF DESCRIPTION OF THE DRAWING

A better understanding of the present invention will be had upon reference to the following detailed description, when read in conjunction with the accompanying drawing, wherein like reference characters refer to like parts throughout the several views, and in which:

FIG. 1 is a flowchart illustrating the operation of a portion of the preferred embodiment of the present invention;

FIGS. 2A and 2B are flowcharts illustrating the operation of a further portion of the preferred embodiment of the present invention;

FIG. 3 is flowcharts illustrating yet a further portion of the preferred embodiment of the present invention;

FIG. 4 is a flowchart illustrating a still further portion of the preferred embodiment of the present invention; and

FIG. 5 is a diagrammatic view of the preferred embodiment of the present invention.

### DETAILED DESCRIPTION OF A PREFERRED EMBODIMENT OF THE PRESENT INVENTION

With reference first to FIG. 5, the system 10 of the present invention is there shown and comprises both a user 12 and a receiver 14 in which the user desires to send application data to the receiver for filing or other action in the country of the receiver. Typically the user 12 and receiver 14 are located in different countries and communicate by computer over a telecommunication network 16, such as the World Wide Web. As such both the receiver 14 and user 12 each have unique URL addresses and when the user 12 enters the URL address for the receiver 14 using the computer browser the home page of the receiver 14 is displayed on the user's monitor 18.

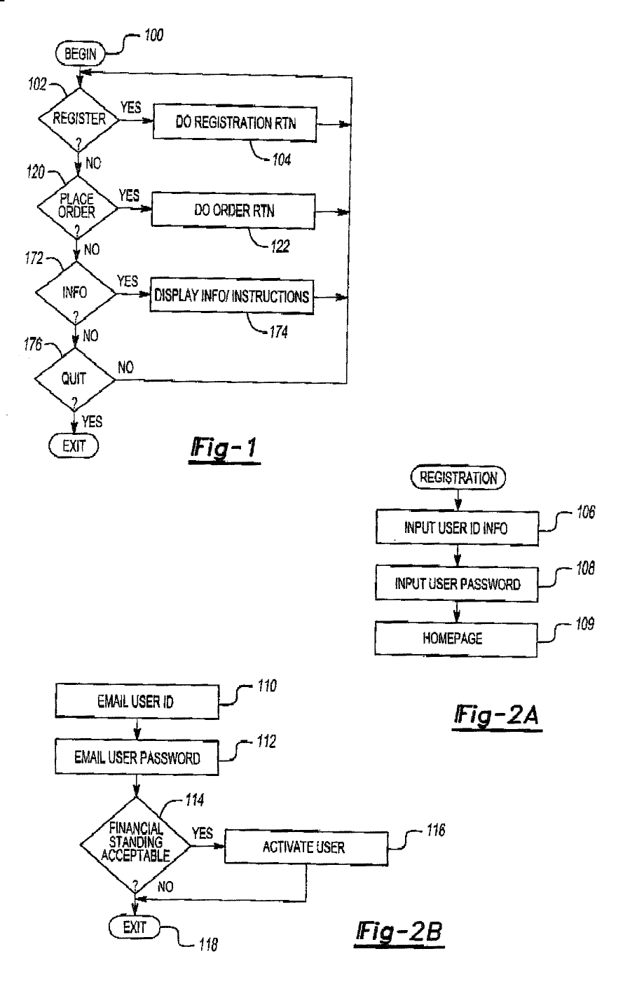

With reference now to FIG. 1, a flowchart illustrating the operation of the present invention is shown. Upon accessing the receiver's home page at step 100, the user 12 is presented with the option of either registering, placing an order, obtaining general information from the receiver, or exiting from the receiver's home page. After the user enters his or her selection using his or her browser, step 100 branches to step 102 to determine if the user desires to register with the receiver. If so, step 102 branches to step 104 and performs the registration routine.

With reference now to FIG. 2A, the registration routine is there shown in greater detail. At step 106, the user 12 inputs the user selected identification (user ID) as well as other user information, such as the user's name, address, telephone number, facsimile number, e-mail address, VAT number and the like. After entry of all of the user identification information, step 106 branches to step 108. At step 108, the user 12 inputs a user selected password which is communicated over the telecommunication network to the receiver. Step 108 then branches to step 109 and returns to the receiver's home page.

With reference to FIG. 2B, after the user 12 has been returned to the home page at step 109, the receiver 14 communicates a message by electronic mail (“e-mail”) to the user 12 notifying the user of the proper receipt of the user ID. Step 110 then branches to step 112 where this receiver 12 communicates the user password back to the user 12 by e-mail. Alternatively, however, both the user ID as well as the user password may be communicated in a single e-mail from the receiver 14 and to the user 12. In either event, receipt by the user of both the user ID as well as the user password from the receiver 14, constitutes a verification that both the user ID and user password have been received by the receiver 14. Step 112 then branches to step 114.

For added security, a separate authorization by the receiver may optionally be used. Thus, at step 114, the receiver 14 may apply whatever criteria are deemed appropriate by the receiver 14 to determine if the user 12 is an acceptable user 12 and, as such, will be authorized by the receiver 14 to use the system. For example, the receiver 14 may determine whether the financial standing or credit worthiness of the user 12 is acceptable to the receiver 14 for credit purposes. If the user 12 is approved and registered, step 114 branches to step 116 in which the user is activated. Step 116 then branches to step 118 which terminates the registration routine by the receiver 14.

With reference again to FIG. 1, after registration, the user may select to place an order at step 120. If so, step 120 branches to step 122 where the order routine is processed.

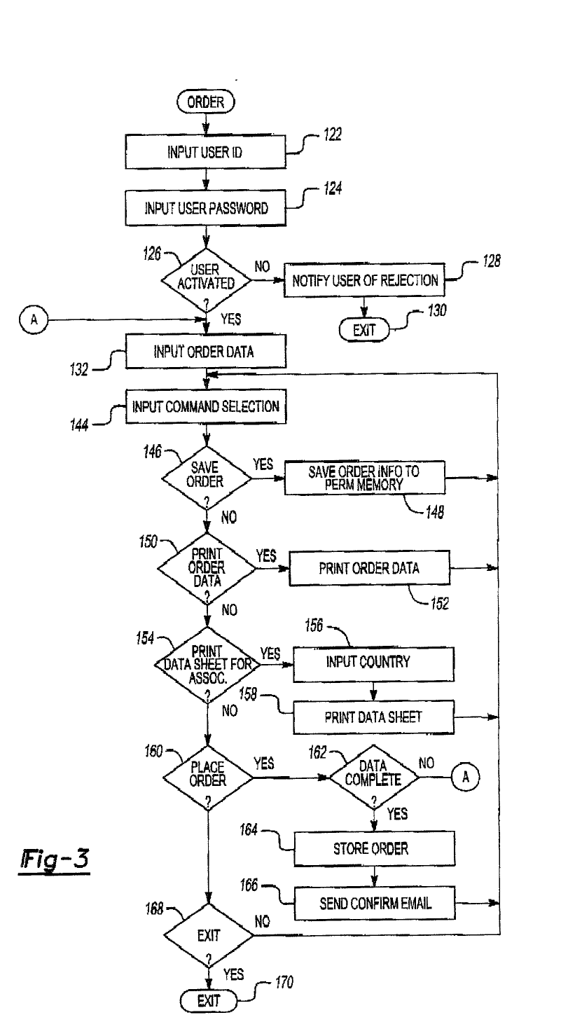

With reference now to FIG. 3, the order routine is there shown in greater detail. At step 122 the user 12 is required to input the user ID and then branches to step 124 where the user 12 is required to input the user password. Step 124 then branches to step 126.

At step 126, the system determines whether or not the user has been activated through a prior registration. If not, step 126 branches to step 128 where the user is notified by the receiver 14 by e-mail that his or her attempt to place an order has been rejected. Step 128 then returns at step 130 to step 100 (FIG. 1).

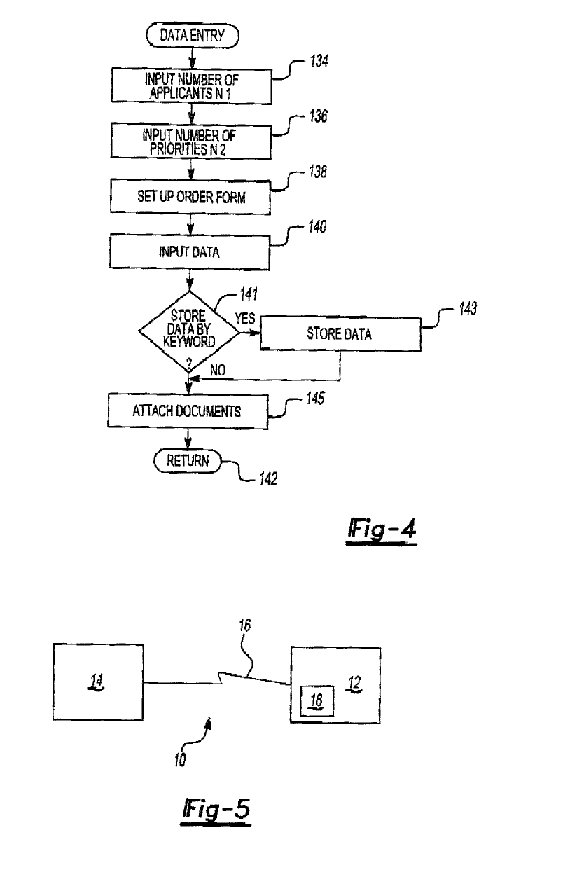

Assuming, however, that the user 12 has been activated, step 126 instead branches to step 132 where the routine for inputting the necessary data relating to the application for the protection of intellectual property is executed. An exemplary data input routine is illustrated in greater detail in FIG. 4 in which the user inputs the number of applicants (N1) at step 134 and then branches to step 136.

At step 136, the user 12 inputs the number of different priorities (N2), i.e. information relating to earlier filed applications for the protection of the intellectual property, typically in countries other than the country of the receiver 14. Step 136 then branches to step 138.

At step 138, the receiver displays an order form utilizing the number of applicants (N1) obtained at step 136 as well as the number of priorities (N2) obtained at step 136 and communicates this order form over the telecommunication network 16 to the user 12. Typically, the order form contains a number of data entry fields, each of which is designed for entry of information relating to the application. Step 138 then branches to step 140 at which the user 12 inputs the data into the data entry fields on the order form displayed on the user's monitor 18 using the user's computer. Upon completion of entry of the data into the order form by the user, step 140 branches to step 141.

Although the user 12 may directly input all of the application data, e.g. the applicant's name and address, inventor name(s) and address(es), list of goods, etc. each time the system is accessed, alternatively the user 12 may store frequently used data at the receiver. Then, at step 140, the user 12 accesses the stored data by keyword thus eliminating the repetitious reentry of frequently used data.

At step 141 the user 12 has the option of storing the entered data by key word, i.e. in an abbreviated form. If elected, step 141 branches to step 143 where the data is stored by the receiver and step 143 then branches to step 145. Otherwise, step 141 branches directly to step 145 where the user 12 may attach documents to be electronically transmitted along with the data to the receiver. Step 145 then branches to step 142 and returns to the main stream for the order routine.

With reference then again to FIG. 3, step 142 next branches to step 144 which provides the user with several different command selections. These command selections include the ability to save the order, print the order data by the user, print a data sheet for other foreign associates by the user, or to place the order at the receiver. After input of the command selection at step 144, step 144 branches to step 146.

At step 146, the program determines if the user has entered the command to save the order. If so, step 146 branches to step 148 where the information relating to the order is stored in persistent memory at the receiver 14. Step 148 then branches back to step 144.

Conversely, if the user has not entered the command to save the order, step 146 instead branches to step 150 where the program determines if the user has entered the command to print the order data. If so, step 150 branches to step 152 where the order data is printed at the user 12, typically by utilizing the print command on the browser for the World Wide Web utilized by the user. Step 152 then branches back to step 144.

If the print order command was not entered by the user, step 150 instead branches to step 154 where the program determines if the command to print the data sheet for associates has been entered by the user. If so, step 154 branches to step 156 where the user inputs the desired country. Step 156 then branches to step 158 where the data sheet for the foreign associate is printed by the user's browser utilizing data telecommunicated from the receiver to the user. The printed data sheet includes the selected country.

Assuming that the print data sheet for associates command was not entered by the user, step 154 instead branches to step 160 where the program determines if the command to place an order was entered by the user. If so, step 160 branches to step 162 which determines if the data inputted by the user is sufficient to constitute a complete application for the protection of the intellectual property. If not, step 162 branches back to step 132 (FIG. 3) which enables the user 12 to correct and/or complete the application data. However, if the data is complete, step 162 instead branches to step 164 where the data for the intellectual property application is stored by the receiver. Step 164 then branches to step 166 where the receiver 14 communicates over the telecommunication network 16 a confirmatory e-mail to the user that the data has been received and saved. Step 166 then branches back to step 144 to await the additional entry of further commands, if desired, by the user.

Lastly, if the command to place an order was not entered by the user, step 160 instead branches to step 168 which determines if the user has selected to exit from the system. This is typically done by entering a new URL address in the user's browser or simply terminating the browser itself. In either event, upon exiting, step 166 branches to step 170 and exits from the overall system.

With reference again to FIG. 1, from the receiver's home page, the user may select to receive information at step 172 from the receiver. Such information may constitute, e.g. instructions for the use of the system. If so, step 172 branches to step 174 where the receiver communicates the desired information to the user 12 over the network 16 and the information is typically displayed on the user's video monitor 18. Step 174 then returns to step 102 to await a subsequent command.

Lastly, the user may exit from the user's home page at step 176 by terminating the browser, entering a new URL address in the browser, or the like.

From the foregoing, it can be seen that the present invention provides both a method and system for communicating data relating to applications for the protection of intellectual property over a telecommunication network, such as the World Wide Web. The present invention not only enables virtually instantaneous communication of such data between the user and receiver, but also provides error checking to ensure that the application data is complete.

Security is maintained between the receiver and the user by utilizing a combination of user identification or user ID as well as user password. Additionally, a secure connection to the World Wide Web may be employed to virtually guarantee complete security. For example, with today's technology, an SSL (Secure Sockets Layer) protocol may be used to provide encrypted, authenticated network communications. Typically used between web browsers and web servers, with an SSL connection each side sends a security certificate to the other, enabling each side to encrypt a transmission using information from both its own and the other side's certificate. This ensures that only the intended recipient can decrypt the communication, and that the other side can be sure the data came from the place it claims to have come from, and that the message has not been tampered with.

Having described my invention, however, many modifications thereto will become apparent to those skilled in the art to which it pertains without deviation from the spirit of the invention as defined by the scope of the appended claims.

I claim:

1. A system for communicating data between a user and a receiver over a telecommunications network, said data relating to filing information for application(s) relating to the protection of intellectual property, said system comprising:
means for initially registering the user to communicate application data over the network to the receiver,
means for receiving data transmitted over the telecommunication network by the user, said data relating to the intellectual property application,
means verifying the completeness of the transmitted data from the user, and
means for communicating over the telecommunication network receipt of the verified data to the user.

2. The system as defined in claim 1 wherein said registering means further comprises means for receiving a user selected password from the user over the telecommunication network, and means for storing said password.

3. The system as defined in claim 1 wherein said telecommunications network comprises the World Wide Web.

4. The system as defined in claim 1 wherein said communication means comprises the means for transmitting an electronic message from the receiver to the user over the network.

5. The invention as defined in claim 1 wherein said receiving means comprises means for receiving the data in batch format.

6. The invention as defined in claim 1 wherein said receiving means comprises means for receiving an attached document in conjunction with the data transmitted to the receiver.

7. The invention as defined in claim 1 wherein said receiving means comprises means for receiving an attached document in electronic form in conjunction with the data transmitted to the receiver.

8. A method for communicating data between a user and a receiver over a telecommunications network, said data relating to filing information for applications relating to the protection of intellectual property, said method comprising the steps of:
the receiver initially registering the user to communicate application data over the network to the receiver,
thereafter the receiver receiving data over the network from the user, said data relating to the intellectual property application,
the receiver verifying the completeness of the transmitted data from the user, and
the receiver confirming receipt of the verified data over the network to the user.

9. The method as defined in claim 8 wherein said registering step further comprises the steps of the user selecting a password, transmitting the password from the user to the receiver over the network, and the receiver storing the password.

10. The method as defined in claim 8 wherein said telecommunications network comprises the World Wide Web.

11. The method as defined in claim 8 wherein said confirming step comprises the step of telecommunicating an electronic message over the network.

12. The method as defined in claim 8 wherein said transmitting step further comprises the step of transmitting data in batch format.

13. The method as defined in claim 8 wherein said transmitting step further comprises the step of transmitting an attached document.

14. A system for communicating data between a user and a receiver over a telecommunications network, said data relating to filing information for application(s) relating to the protection of intellectual property, said system comprising:
means for receiving data transmitted over the telecommunication network by the user, said data relating to the intellectual property application,
means for storing frequently used data at the receiver, said frequently used data being subsequently accessible by key word by the user, and
means for communicating over the telecommunication network receipt of the data to the user.

15. A system for communicating data between a user and a receiver over a telecommunications network, said data relating to filing information for application(s) relating to the protection of intellectual property, said system comprising:
means for receiving data transmitted over the telecommunication network by the user, said data relating to the intellectual property application and containing information relating to a variable number of data entries for a data item,
means for the receiver to transmit a data entry form over the telecommunication network to the user reflecting said number of data entries for said data item,
means verifying the completeness of the transmitted data from the user, and
means for communicating over the telecommunication network receipt of the verified data to the user.

16. The system as defined in claim 15 wherein said data item comprises applicant identification data.

17. The system as defined in claim 15 wherein said data item comprises application priority data.

18. The system as defined in claim 15 wherein said means for receiving data further comprises means for receiving an attached document in conjunction with said data.
